(19) United States
(12) Patent Application Publication
(10) Pub. No.: US 2024/0345462 A1
(43) Pub. Date: Oct. 17, 2024

(54) LIGHT SOURCE MODULE AND PROJECTION DEVICE

(71) Applicant: Coretronic Corporation, Hsin-Chu (TW)

(72) Inventor: Hou-Sheng Wang, Hsin-Chu (TW)

(73) Assignee: Coretronic Corporation, Hsin-Chu (TW)

(21) Appl. No.: 18/631,024

(22) Filed: Apr. 9, 2024

(30) Foreign Application Priority Data
Apr. 12, 2023 (CN) 202310385928.5

(51) Int. Cl. G03B 21/20

(52) U.S. Cl. CPC G03B 21/2013; G03B 21/2066

(57) ABSTRACT

Provided is a light source module, including a light emitting element and a light splitting module. The light emitting element provides a first beam. The light splitting module converts the first beam into multiple light splitting beams. The light splitting module includes a first light splitting element, a first optical element, and a reflective element. The first light splitting element is configured to divide the first beam into a first light splitting beam and a second beam. The first optical element is disposed on a transmission path of the second beam, and is configured to change a polarization state of the second beam. The reflective element is disposed on a transmission path of the first light splitting beam or a transmission path of at least part of the second beam. The light splitting beams include the first light splitting beam and the at least part of the second beam.

### CROSS-REFERENCE TO RELATED APPLICATION

This application claims the priority benefit of China application serial no. 202310385928.5, filed on Apr. 12, 2023. The entirety of the above-mentioned patent application is hereby incorporated by reference herein and made a part of this specification.

### BACKGROUND

### Technical Field

The disclosure relates to an optical module and an electronic device, and more particularly, to a light source module and a projection device.

### Description of Related Art

With the evolution and innovation of technology, a projection device has been constantly improving. An imaging principle of the projection device is to convert an illumination beam generated by an illumination system into an image beam through a light valve, and then project the image beam to a projection target (such as a screen or wall) through a projection lens to form a projection image.

However, in the current technology that uses a light source of the illumination system, due to luminous characteristics of the light source, generated light spots will have an issue of speckle. Therefore, the speckle of the light source is one of the issues that is required to be overcome in a projection system. In addition, how to improve uniformity of the light source is also one of the objectives in the art.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides alight source module and a projection device, which may reduce a speckle phenomenon and enhance an optical effect.

Other objectives and advantages of the disclosure may be further understood from the technical features disclosed herein.

In order to achieve one, a part, or all of the above objectives or other objectives, the disclosure provides a light source module, including a light emitting element and a light splitting module. The light emitting element is configured to provide a first beam. The light splitting module is configured to convert the first beam into multiple light splitting beams. The light splitting module includes a first light splitting element, a first optical element, and a reflective element. The first light splitting element is disposed on a transmission path of the first beam to divide the first beam into a first light splitting beam and a second beam. The first optical element is disposed on a transmission path of the second beam, and is configured to change a polarization state of the second beam. The reflective element is disposed on a transmission path of the first light splitting beam or a transmission path of at least part of the second beam. The light splitting beams include the first light splitting beam and the at least part of the second beam.

In order to achieve one, a part, or all of the above objectives or other objectives, the disclosure further provides a projection device, including an illumination system, at least one light valve, and a projection lens. The illumination system is configured to provide an illumination beam. The illumination system includes at least one light source module, and the at least one light source module includes a light emitting element and a light splitting module. The light emitting element is configured to provide a first beam. The light splitting module is configured to convert the first beam into multiple light splitting beams. The light splitting module includes a first light splitting element, a first optical element, and a reflective element. The first light splitting element is disposed on a transmission path of the first beam to divide the first beam into a first light splitting beam and a second beam. The first optical element is disposed on a transmission path of the second beam, and is configured to change a polarization state of the second beam. The reflective element is disposed on a transmission path of the first light splitting beam or a transmission path of at least part of the second beam. The light splitting beams include the first light splitting beam and the at least part of the second beam. The at least one light valve is disposed on a transmission path of the illumination beam to convert the illumination beam into an image beam. The projection lens is disposed on a transmission path of the image beam to project the image beam out of the projection device.

Based on the above, the embodiments of the disclosure have at least one of the following advantages or functions. In the light source module and the projection device of the disclosure, the light source module includes the light emitting element and a light splitting module, and the light splitting module includes the light splitting element, the optical element, and the reflective element. The light splitting module is configured to convert the beam provided by the light emitting element into the light splitting beams. The energy of each of the light splitting beams is substantially the same, and at least part of the polarization state is different. In this way, the speckle phenomenon may be reduced, thereby improving the optical effect of the illumination system in the projection device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projection device according to an embodiment of the disclosure.

FIG. 2A is a schematic view of an illumination system according to an embodiment of the disclosure.

FIG. 2B is a schematic view of a first optical element of the illumination system according to the embodiment of FIG. 2A.

FIG. 2C is a schematic view of an illumination system according to another embodiment of the disclosure.

FIG. 3 is a schematic view of an illumination system according to another embodiment of the disclosure.

FIG. 4 is a schematic view of an illumination system according to another embodiment of the disclosure.

FIG. 5 is a schematic view of an illumination system according to another embodiment of the disclosure.

FIG. 6 is a schematic view of an illumination system according to another embodiment of the disclosure.

FIG. 7 is a schematic view of an illumination system according to another embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive

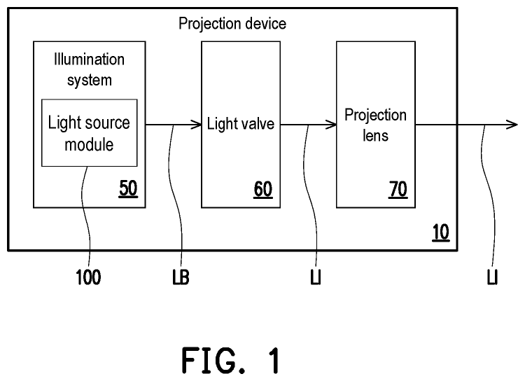

FIG. 1 is a schematic view of a projection device according to an embodiment of the disclosure. Referring to FIG. 1, in this embodiment, a projection device 10 including an illumination system 50, at least one light valve 60, and a projection lens 70 is provided. The illumination system 50 is configured to provide an illumination beam LB, and includes at least one light source module 100. The at least one light valve 60 is disposed on a transmission path of the illumination beam LB to convert the illumination beam LB into an image beam LI. The projection lens 70 is disposed on a transmission path of the image beam LI, and is configured to project the image beam LI out of the projection device 10 to a projection target (not shown), such as a screen or a wall.

The light valve 60 is, for example, a reflective light modulator, such as a liquid crystal on silicon panel (LCoS panel) or a digital micro-mirror device (DMD). In some embodiments, the light valve 60 may also be a transparent light modulator, such as a transparent liquid crystal panel, an electro-optical modulator, a magneto-optic modulator, or an acousto-optic modulator (AOM). The disclosure does not limit a form and type of the light valve 60. Detailed steps and implementation of a method for converting the illumination beam LB into the image beam LI by light valve 60 may be obtained from the common knowledge in the technical field with sufficient teaching, suggestion, and implementation, so no further description is incorporated herein. In this embodiment, the number of light valves 60 is one, such as the projection device 10 using a single digital micro-mirror device, but in other embodiments, there may be more than one. The disclosure is not limited thereto.

The projection lens 70 includes, for example, a combination of one or more optical lenses with diopters, such as various combinations of non-planar lenses such as biconcave lenses, biconvex lenses, concave-convex lenses, convex-concave lenses, plano-convex lenses, and plano-concave lenses. In an embodiment, the projection lens 70 may further include a planar optical lens to project the image beam LI from the light valve 60 to the projection target in a reflective manner. The disclosure does not limit a form and type of the projection lens 70.

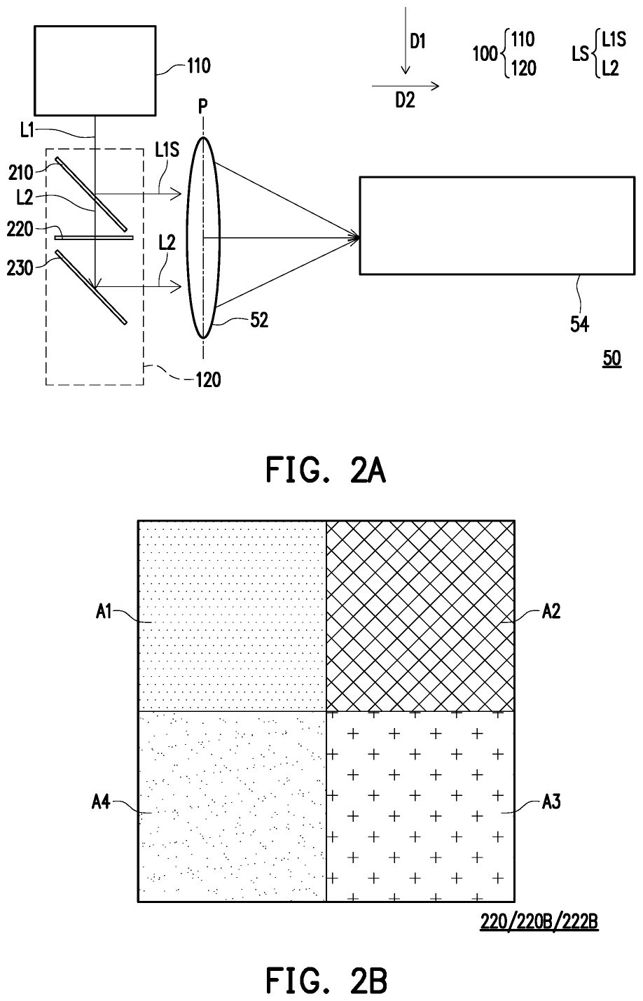

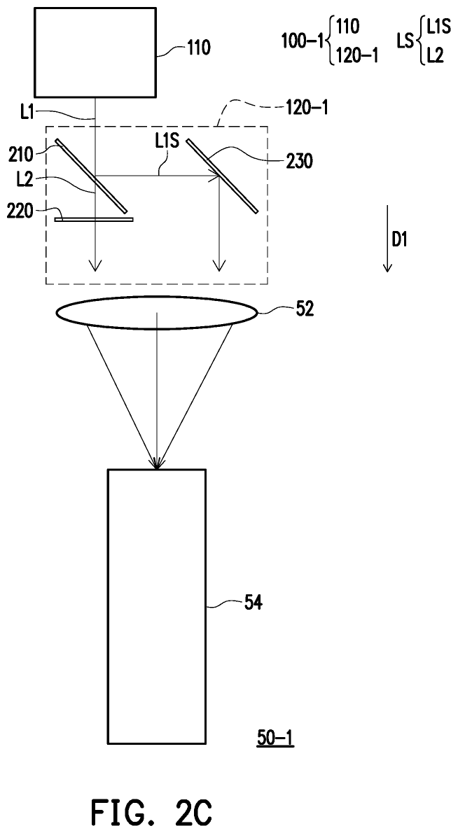

FIG. 2A is a schematic view of an illumination system according to an embodiment of the disclosure. Referring to FIG. 2A, in this embodiment, the illumination system 50 includes the at least one light source module 100. The illumination system 50 is configured to provide the illumination beam LB. The at least one light source module 100 is configured to provide multiple light splitting beams LS. The illumination beam LB includes the light splitting beams LS. The number of at least one light source modules 100 may be one or more. In this embodiment, the illumination system 50 may further include a focus lens 52 and a light homogenizing element 54. The focus lens 52 is disposed on an imaging plane P (a beam illuminating surface) of an optical system formed by the light source module 100, the focus lens 52 is configured to focus the light splitting beams LS. The light homogenizing element 54 is disposed on a transmission path of the light splitting beams LS from the focus lens 52. The light splitting beams LS (i.e., the illumination beam LB) are further shaped through the focus lens 52 and the light homogenizing element 54. The light homogenizing element 54 is, for example, a light integration rod. In other embodiments, the light homogenizing element 54 may also be other suitable types of optical elements, such as a lens array (fly eye lens array). The disclosure does not limit a type or form of other elements in the illumination system 50. Detailed structures and implementations thereof may be obtained from the common knowledge in the technical field with sufficient teaching, suggestion and implementation, so no further description is incorporated herein. In other embodiments, the illumination system 50 may further include a wavelength conversion element, a filter element, and/or a light splitting and combing element to provide beams of different wavelengths. The disclosure is not limited thereto.

In this embodiment, the illumination system 50 includes the single light source module 100, and the light source module 100 includes a light emitting element 110 and a light splitting module 120. The light emitting element 110 is a laser diode (LD), or the light emitting element 110 includes multiple laser diodes. The light emitting element 110 is configured to provide a first beam L1. The light splitting module 120 is configured to convert the first beam L1 into the light splitting beams LS, and directions of the light splitting beams LS leaving the light splitting module 120 are the same (for example, a difference is within 10 degrees).

The light splitting module 120 includes a first light splitting element 210, a first optical element 220, and a reflective element 230. The first light splitting element 210, the first optical element 220, and the reflective element 230 are sequentially arranged along a first direction D1, and the first direction D1 is, for example, a direction of the first beam L1 emitted by the light emitting element 110. The first light splitting element 210 is disposed on a transmission path of the first beam L1 to divide the first beam L1 into a first light splitting beam L1S and a second beam L2. An included angle between an optical surface of the first light splitting element 210 and the first direction D1 is, for example, 45 degrees. The optical surface of the first light splitting element 210 is the light emitting surface or the light exiting surface of the first light splitting element 210. In this embodiment, the first light splitting element 210 is, for example, a half mirror, which is configured to reflect 50% or about 50% of the first beam L1 to form the first light splitting beam L1S and allow the other 50% or about 50% of the first beam L1 to pass through to form the second beam L2. Therefore, energy of the first light splitting beam L1S is substantially the same as energy of the second beam L2 (e.g., a difference in light energy is less than 5%).

The first optical element 220 is disposed on a transmission path of the second beam L2 from the first light splitting element 210, and is configured to change a polarization state of the second beam L2. The first optical element 220 is, for example, a quarter-wave plate, a half-wave plate, a depolarizer, or a composite wave plate. The depolarizer is configured to change an original polarization state of the beam, so that the beam does not have a specific polarization state. The composite wave plate includes, for example, a half-wave plate area A1, a three-quarter wave plate area A2, a quarter-wave plate area A3, and a light-transmitting area A4, and is formed by splicing the above areas, as shown in FIG. 2B. Therefore, the polarization state of the second beam L2 passing through the first optical element 220 will be different from a polarization state of the first light splitting beam L1S. In other embodiments, the first light splitting element 210 and the first optical element 220 are disposed sequentially along a second direction D2, the first optical element 220 is disposed on a transmission path of the second beam L2 reflected by the first light splitting element 210, the reflective element 230 is disposed on a transmission path of the first light splitting beam L1S from the first light splitting element 210, so that the polarization state of the second beam L2 passing through the first optical element 220 will also be different from the polarization state of the first light splitting beam L1S.

In the embodiment of FIG. 2A, the reflective element 230 is disposed on the transmission path of the second beam L2 from the first optical element 220 to reflect the second beam L2. An included angle between an optical surface (a reflective surface) of the reflective element 230 and the first direction D1 is, for example, 45 degrees. Therefore, a transmitting direction of the second beam L2 reflected by the reflective element 230 is the same as a transmitting direction of the first light splitting beam L1S. With the configuration of the first light splitting element 210, the first optical element 220, and the reflective element 230, the first beam L1 will form the first light splitting beam L1S and the second beam L2, and the first light splitting beam L1S and the second beam L2 are transmitted toward the focus lens 52 by the light splitting module 120 along the second direction D2 perpendicular to the first direction D1. In this way, in this embodiment, the first beam L1 provided by the light emitting element 110 may be formed into the light splitting beams LS through the first light splitting element 210, the first optical element 220, and the reflective element 230 in the light splitting module 120. The light splitting beams LS include the first light splitting beam L1S and the second beam L2, and polarization states of the light splitting beams LS are different from one another. Therefore, a speckle phenomenon may be reduced, thereby improving an optical effect of the illumination system 50. In other embodiments, the reflective element 230 and the first optical element 220 are disposed sequentially along the second direction D2, the first optical element 220 is disposed on a transmission path of the second beam L2 reflected by the reflective element 230, so that the polarization state of the second beam L2 passing through the first optical element 220 will also be different from the polarization state of the first light splitting beam L1S.

FIG. 2C is a schematic view of an illumination system according to another embodiment of the disclosure. Referring to FIG. 2C, an illumination system 50-1 in this embodiment is similar to the illumination system 50 shown in FIG. 2A. A difference between the two lies (FIG. 2C and FIG. 2A) in a configuration position of the reflective element 230. In this embodiment, the first light splitting element 210 and the first optical element 220 of a light splitting module 120-1 of a light source module 100-1 are sequentially arranged along the first direction D1. The first light splitting element 210 is disposed on the transmission path of the first beam L1 to reflect 50% or about 50% of the first beam L1 to form the first light splitting beam L1S and allow the other 50% or about 50% of the first beam L1 to pass through to form the second beam L2. The reflective element 230 is disposed on the transmission path of the first light splitting beam L1S to reflect the first light splitting beam L1S. In this way, the second beam L2 and the first light splitting beam L1S with different polarization states form the light splitting beams LS, and are transmitted toward the focus lens 52 in the same direction (the first direction D1). Therefore, the speckle phenomenon may be reduced, thereby further improving an optical effect of the illumination system 50-1.

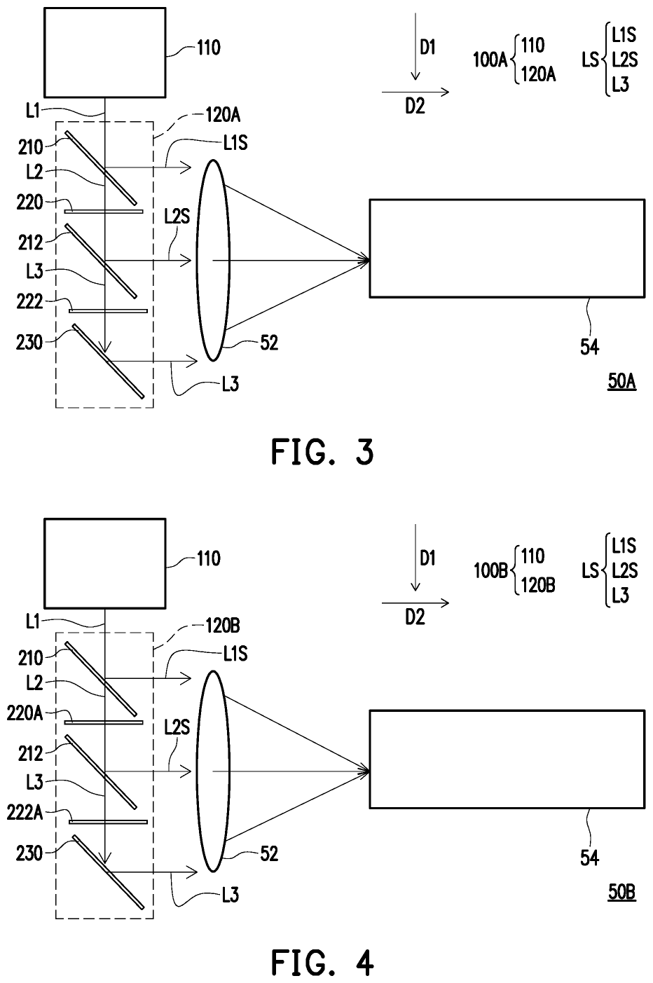

FIG. 3 is a schematic view of an illumination system according to another embodiment of the disclosure. Referring to FIG. 3, an illumination system 50A in this embodiment is similar to the illumination system 50 shown in FIG. 2A. A difference between the two is that in the illumination system 50A in this embodiment, a light splitting module 120A of a light source module 100A further includes a second light splitting element 212 and a second optical element 222. In this embodiment, the first light splitting element 210, the first optical element 220, the second light splitting element 212, the second optical element 222, and the reflective element 230 are sequentially arranged along the first direction D1. The second light splitting element 212 is disposed on the transmission path of the second beam L2 from the first optical element 220. Similar to the first light splitting element 210, the second light splitting element 212 is configured to divide the second beam L2 into a second light splitting beam L2S and a third beam L3. A reflectivity of the first light splitting element 210 and a range of a reflectivity of the second light splitting element 212 are different. In this embodiment, the range of the reflectivity of the first light splitting element 210 is 30% to 40%, and the range of the reflectivity of the second light splitting element 212 is 45% to 55%. In an embodiment, the reflectivity of the first light splitting element 210 is 35% or about 35%, and the reflectivity of the second light splitting element 212 is 50% or about 50%.

On the other hand, the second optical element 222 is disposed on a transmission path of the third beam L3 from the second light splitting element 212, and similar to the first optical element 220, the second optical element 222 is configured to change a polarization state of the third beam L3. The reflective element 230 is disposed on the transmission path of the third beam L3 (i.e. at least part of the second beam L2) from the second optical element 222. The light splitting beams LS include the first light splitting beam L1S, the second light splitting beam L2S, and the third beam L3. In this embodiment, the first optical element 220 and the second optical element 222 are a quarter-wave plate and a half-wave plate respectively. Therefore, the polarization states of the first light splitting beam L1S, the second light splitting beam L2S, and the third beam L3 may be all different.

In this embodiment, a light intensity difference of each of the light splitting beams LS is less than 10%. Since the reflectivity of the first light splitting element 210 is 35% (or about 35%), and the reflectivity of the second light splitting element 212 is 50% (or about 50%), light intensity of the first light splitting beam L1S is 35% (or about 35%) of light intensity of the first beam L1, light intensity of the second light splitting beam L2S is 32.5% (or about 32.5%) of the light intensity of the first beam L1, and light intensity of the third beam L3 is 32.5% (or about 32.5%) of the light intensity of the first beam L1. In this way, the first beam L1 provided by the light emitting element 110 may form the light splitting beams LS through an optical function of the light splitting module 120A, and the polarization states of the light splitting beams LS are different from one another. Therefore, the speckle phenomenon may be reduced, thereby improving an optical effect of the illumination system 50A.

FIG. 4 is a schematic view of an illumination system according to another embodiment of the disclosure. Referring to FIG. 4, an illumination system 50B in this embodiment is similar to the illumination system 50A shown in FIG. 3. A difference between the two is that in the illumination system 50B in this embodiment, a first optical element 220A and a second optical element 222A of a light splitting module 120B of a light source module 100B are both the depolarizers. Therefore, the first light splitting beam L1S, the second light splitting beam L2S, and the third beam L3 may all be depolarized to achieve a better uniform effect.

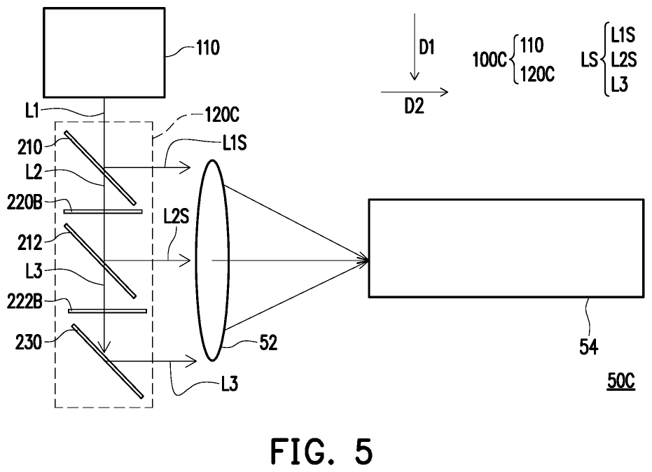

FIG. 5 is a schematic view of an illumination system according to another embodiment of the disclosure. Referring to FIG. 5, an illumination system 50C in this embodiment is similar to the illumination system 50A shown in FIG. 3. A difference between the two is that in the illumination system 50C in this embodiment, a first optical element 220B and a second optical element 222B of a light splitting module 120C of a light source module 100C are both the composite wave plates as shown in FIG. 2B. Therefore, the polarization states of the first light splitting beam L1S, the second light splitting beam L2S, and the third beam L3 may be all different, and the better uniform effect may be achieved.

The light splitting modules in FIG. 3 to FIG. 5 are illustrated with two light splitting elements, two optical elements, and one reflective element. In other embodiments, the number of light splitting elements and optical elements may be greater than two, so that more light splitting beams with different polarization states may be generated.

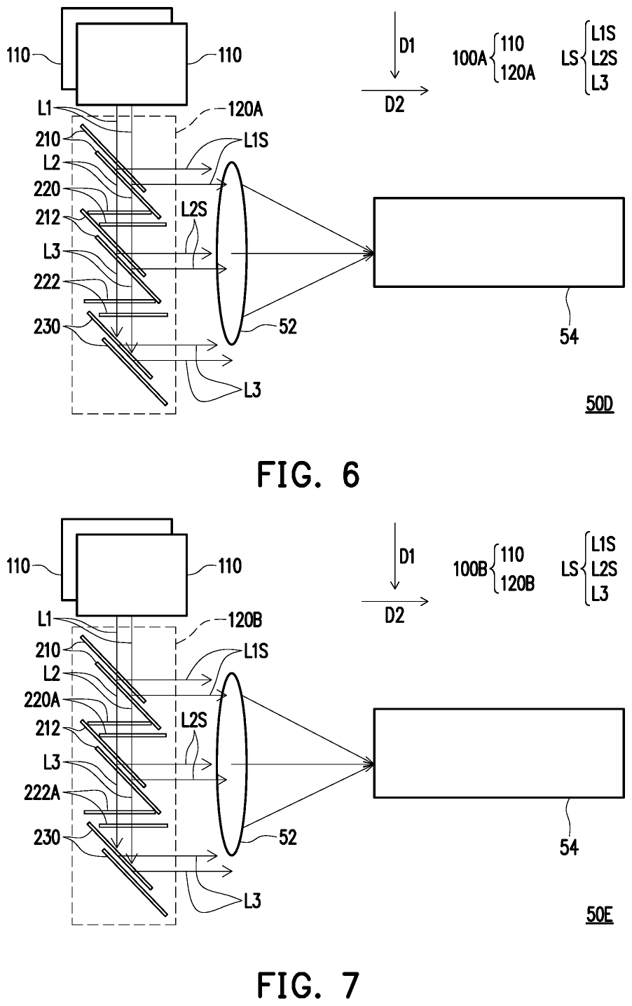

FIG. 6 is a schematic view of an illumination system according to another embodiment of the disclosure. Referring to FIG. 6, an illumination system 50D in this embodiment is similar to the illumination system 50A shown in FIG. 3. A difference between the two is that in this embodiment, two sets of light source modules 100A as in the embodiment shown in FIG. 3 are used in the illumination system 50D. In this embodiment, the first optical element 220 and the second optical element 222 in one set of light source modules 100A are both the quarter-wave plates, while the first optical element 220 and second optical element 222 in the other set of light source modules 100A may be the half-wave plate and the quarter-wave plate respectively. The first beams L1 respectively provided by the light emitting elements 110 in the two sets of light source modules 100A are only transmitted and split between the light splitting modules 120A in the respective light source modules 100A. For example, the two sets of light source modules 100A are spatially misaligned. As a result, the light splitting elements and the optical elements of different sets of light source modules will not interfere with the beam of the other set. For example, on a reference plane formed by the first direction D1 and the second direction D2, orthographic projections of the two sets of light source modules 100A on the reference plane at least partially overlap. In a direction perpendicular to the reference plane, the two sets of light source modules 100A do not overlap. Therefore, the first light splitting beam L1S, the second light splitting beam L2S, and the third beam L3 respectively provided by the two sets of light source modules 100A may have at least four different polarization states. In this way, the speckle phenomenon may be reduced, thereby improving an optical effect of the illumination system 50D.

FIG. 7 is a schematic view of an illumination system according to another embodiment of the disclosure. Referring to FIG. 7, an illumination system 50E in this embodiment is similar to the illumination system 50D shown in FIG. 6. A difference between the two is that in this embodiment, two sets of light source modules 100B as in the embodiment shown in FIG. 4 are used in the illumination system 50E. In other words, in this embodiment, the first optical element 220 and the second optical element 222 of the two sets of light source modules 100B include four pieces of depolarizers. Similar to the embodiment in FIG. 6, the first beams L1 respectively provided by the light emitting elements 110 in the two sets of light source modules 100B are only transmitted and split between the light splitting modules 120B in the respective light source modules 100B. Therefore, the first light splitting beam L1S, the second light splitting beam L2S, and the third beam L3 respectively provided by the two sets of light source modules 100B may have four different polarization states. In this way, the speckle phenomenon may be reduced, thereby improving an optical effect of the illumination system 50E.

Based on the above, in the light source module and the projection device of the disclosure, the light source module includes the light emitting element and a light splitting module, and the light splitting module includes the light splitting element, the optical element, and the reflective element. The light splitting module is configured to convert the beam provided by the light emitting element into the light splitting beams. The energy of each of the light splitting beams is substantially the same, and at least part of the polarization state is different. In this way, the speckle phenomenon may be reduced, thereby improving the optical effect of the illumination system in the projection device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to allow persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, comprising:
a light emitting element, configured to provide a first beam; and
a light splitting module, configured to convert the first beam into a plurality of light splitting beams, wherein the light splitting module comprises a first light splitting element, a first optical element, and a reflective element, wherein
the first light splitting element is disposed on a transmission path of the first beam, and is configured to divide the first beam into a first light splitting beam and a second beam;
the first optical element is disposed on a transmission path of the second beam, and is configured to change a polarization state of the second beam; and
the reflective element is disposed on a transmission path of the first light splitting beam or a transmission path of at least part of the second beam;
wherein the light splitting beams comprise the first light splitting beam and the at least part of the second beam.

2. The light source module according to claim 1, wherein the light splitting module further comprises a second light splitting element and a second optical element, wherein
the second light splitting element is disposed on a transmission path of the second beam from the first optical element to divide the second beam into a second light splitting beam and a third beam;
the second optical element is disposed on a transmission path of the third beam from the second light splitting element, and is configured to change a polarization state of the third beam, the reflection element is disposed on a transmission path of at least part of the third beam from the second optical element, the light splitting beams comprise the first light splitting beam, the second light splitting beam, and the at least part of the third beam.

3. The light source module according to claim 2, wherein a light intensity difference of each of the light splitting beams is less than 10%.

4. The light source module according to claim 2, wherein a reflectivity of the first light splitting element and a reflectivity of the second light splitting element are different.

5. The light source module according to claim 2, wherein a range of a reflectivity of the first light splitting element is 30% to 40%, and a range of a reflectivity of the second light splitting element is 45% to 55%.

6. The light source module according to claim 2, wherein the first optical element and the second optical element are a quarter-wave plate and a half-wave plate respectively.

7. The light source module according to claim 1, wherein the first light splitting element, the first optical element, and the reflective element of the light splitting module are sequentially arranged along a first direction, the first light splitting element is configured to reflect the first light splitting beam and allow the second beam to pass through, the reflective element is disposed on a transmission path of the second beam from the first optical element and is configured to reflect the second beam, and the light splitting beams comprise the first light splitting beam and the second beam.

8. The light source module according to claim 7, wherein the light splitting module further comprises a second light splitting element and a second optical element, and the first light splitting element, the first optical element, the second light splitting element, the second optical element, and the reflective element are sequentially arranged along the first direction, wherein
the second light splitting element is disposed on the transmission path of the second beam from the first optical element to divide the second beam into a second light splitting beam and a third beam;
the second optical element is disposed on a transmission path of the third beam from the second light splitting element, and is configured to change a polarization state of the third beam, the reflective element is disposed on the transmission path of the third beam from the second optical element, and the light splitting beams comprise the first light splitting beam, the second light splitting beam, and the third beam.

9. The light source module according to claim 8, wherein the light splitting beams are transmitted along a second direction, and the second direction is perpendicular to the first direction.

10. The light source module according to claim 1, wherein the first optical element is a depolarizer.

11. The light source module according to claim 1, wherein the first optical element is a composite wave plate, and the composite wave plate comprises a half-wave plate area, a three-quarter wave plate area, and a quarter-wave plate area, and a light-transmitting area.

12. A projection device, comprising:
an illumination system, configured to provide an illumination beam, the illumination system comprises at least one light source module, and the at least one light source module comprises a light emitting element and a light splitting module, wherein
the light emitting element is configured to provide a first beam; and
the light splitting module is configured to convert the first beam into a plurality of light splitting beams, wherein the light splitting module comprises a first light splitting element, a first optical element, and a reflective element, wherein
the first light splitting element is disposed on a transmission path of the first beam and is configured to divide the first beam into a first light splitting beam and a second beam;
the first optical element is disposed on a transmission path of the second beam, and is configured to change a polarization state of the second beam; and
the reflective element is disposed on a transmission path of the first light splitting beam or a transmission path of at least part of the second beam, wherein the light splitting beams comprise the first light splitting beam and the at least part of the second beam;
and
at least one light valve, disposed on a transmission path of the illumination beam and configured to convert the illumination beam into an image beam, and the illumination beam comprises the light splitting beams; and
a projection lens, disposed on a transmission path of the image beam and configured to project the image beam out of the projection device.
